(19) United States
(12) Patent Application Publication
(10) Pub. No.: US 2024/0119708 A1
(43) Pub. Date: Apr. 11, 2024

(54) EXTRACTING FEATURES FROM SENSOR DATA

(71) Applicant: Five AI Limited, Cambridge (GB)

(72) Inventors: John Redford, Cambridge (GB); Sina Samangooei, Cambridge (GB); Anuj Sharma, Cambridge (GB); Puneet Dokania, Cambridge (GB)

(73) Assignee: Five AI Limited, Cambridge (GB)

(21) Appl. No.: 18/272,916

(22) PCT Filed: Jan. 19, 2022
(86) PCT No.: PCT/EP2022/051151

§ 371 Date: Jul. 18, 2023

(30) Foreign Application Priority Data
Jan. 20, 2021 (GB) 2100739.8

(51) Int. Cl. G06V 10/774; G06V 10/44; G06V 10/766; G06V 10/776

(52) U.S. Cl. CPC G06V 10/774; G06V 10/44; G06V 10/766; G06V 10/776

(57) ABSTRACT

A computer implemented method of training an encoder to extract features from sensor data comprises generating a plurality of training examples, each training example comprising at least two data representations of a set of sensor data, the at least two data representations related by a transformation parameterized by at least one numerical transformation value; and training the encoder based on a self-supervised regression loss function applied to the training examples. The encoder extracts respective features from the at least two data representations of each training example, and at least one numerical output value is computed from the extracted features. The self-supervised regression loss function encourages the at least one numerical output value to match the at least one numerical transformation value parameterizing the transformation.

### TECHNICAL FIELD

The present disclosure pertains generally to feature extraction, and in particular to training methods that can learn to extract useful features from sensor data, as well as trained feature extractors that can be applied to sensor data.

### BACKGROUND

Broadly speaking, supervised machine learning (ML) aims to learn some function given only examples pairs of inputs and outputs (\tilde{x}, \tilde{y}) (the training set {(\tilde{x}, \tilde{y})}). Here, “\tilde{x}” is a training input, and “\tilde{y}” is variously termed a label, annotation or ground truth. Denoting an ML model as f(x; w), the model computes an output y=f(x; w) for some input x based on a set of learned parameters w. During training, the aim is to learn values of the parameters w that substantially match the outputs of the ML model, y=f(X; w), to the labels, \tilde{y}, across the training set {(\tilde{x}, \tilde{y})}. The model is said to generalize from the training set, in that, once trained, it can be meaningfully applied to an unlabelled input not encountered during training.

A broad application of ML is perception. Perception means the interpretation of sensor data of one or more modalities, such as image, radar and/or lidar. Perception includes object recognition tasks, such as object detection, object localization and class or instance segmentation. Such tasks can, for example, facilitate the understanding of complex multi-object scenes captured in sensor data. Computer-implemented perception tasks are widely applicable across a range of technical fields. For example, perception is a critical component of autonomous vehicle (AV) systems and advanced driver-assistance systems (ADAS).

State-of-the-art performance on computer-implemented perception tasks has been achieved via machine learning (ML), with many key performance gains attributed to deep convolutional neural networks (CNNs) trained on very large data sets.

Computer vision (CV)—the interpretation of image data—is a subset of perception. Recent years have seen material developments in ML applied to image recognition and other CV tasks. A key benchmark is provided by the ImageNet database, containing millions of images annotated with object classes. Breakthrough performance on the ImageNet challenge was achieved by AlexNet in 2012, a convolutional neural network (CNN) trained on GPU hardware. Since then, CNN architectures have continued to set the bar for state-of-the-art performance for image classification tasks.

A challenge with CNNs and deep networks is the need for large amounts of training data—typically hundreds of thousands or millions of annotated training images are needed to achieve state-of-the-art performance. Moreover, the complexity of the training data increases with the complexity of the task to be learned: for basic image classification (classifying whole images), simple class labels are sufficient; but more involved tasks require more complex annotation, such as annotated bounding boxes for object recognition or per-pixel classifications for image segmentation.

“Shared learning” techniques, such as transfer learning or multi-task learning, go some way to addressing these issues. Shared learning seeks to share learned knowledge across multiple tasks. For example, this may involve the learning of robust feature representations of sensor data (features) that are shared between multiple tasks. Learning of such feature representations may be referred to as “representation learning” or “feature learning”.

In transfer learning, an ML system is initially trained on a first task (the “pre-training” or “pretext” phase), and subsequently trained on a second task in a way that incorporates knowledge learned in the training on the first task (“fine-tuning”). Feature leaning occurs in the pre-training phase, and the learned features are used to learn and perform the second task. The first task may be referred to as a “dummy” task because it is often the second task (the desired task) that is of interest in this context. An ML system might comprise a first component, variously termed the encoder, body or feature extractor, and a second component, sometimes termed the head. In high-level terms, the encoder receives an input (such as an image or images), processes the input to extract features, and passes the features to the head, which in turn processes those features in order to compute an output. In pre-training, the encoder may be connected to a “dummy” head, and the dummy head and the encoder might be trained simultaneously on the dummy task using annotated training inputs commensurate with the dummy task. In pre-training, the aim is to match the outputs of the dummy head to the annotations. In computer vision, that first task might be a simple image classification task; although this will generally require a large volume of training data, the form of annotation (per-image class labels) is relatively simple, reducing the annotation burden. Because the encoder and the head are trained simultaneously, it is not only parameters of the head that that are optimized—the encoder also learns parameters for extracting optimal features for the classification task at hand (a form of feature learning). After pre-training, the dummy head might be discarded, and the now-trained encoder connected to a new and as-yet untrained head. In fine turning, the encoder parameters learned in pre-training on the dummy task (e.g., image classification) may be frozen, with only the parameters of the new head being optimised on the desired second task. The desired task could, for example, be an object detection task such as object localization, e.g., bounding box detection (predicting bounding boxes around objects), or image segmentation (predicting individual object pixels), requiring annotated 2D bounding boxes (or object localization ground truth more generally) and annotated segmentation masks respectively. Although the features have been learned through training on the dummy task, the assumption is that, by choosing an appropriate dummy task, the knowledge encoded in the pre-trained encoder weights should be largely applicable to the desired task as well; the features extracted by the pre-trained encoder should, therefore, be useful to the new head in performing the desired task, significantly reducing the amount of training data required to train the new head. For example, once a network has been pre-trained on a suitable classification task, it can be fine-tuned to bounding box detection or image segmentation with only a relatively small number of annotated bounding boxes or annotated segmentation masks. The effectiveness of transfer learning in image processing has been demonstrated on various image processing tasks in recent years.

Multi-task learning is another shared learning approach. Rather than separating pre-training from fine-tuning, in multi-task learning, a machine learning system is trained simultaneously on multiple tasks. In practice, this typically involves some shared encoder architecture—for example, a dummy head and a desired head may each be connected to a shared encoder, with the heads and the encoder trained simultaneously on dummy and desired tasks though optimization of an appropriate multi-task loss.

It will be appreciated that the terms “dummy” and “desired” are merely convenient labels—the terminology does not necessarily imply that the dummy task is trivial or useless (that may or may not be the case). Rather, all that terminology implies some mechanism (including but not limited to transfer learning and multitask learning) by which knowledge learned in training on some first task (the dummy task) is shared in the learning of some second task (the desired task). In this context, the term “feature learning” refers to the training of the encoder (whether through pre-training on the encoder and dummy head, multi-task training on the encoder, dummy head and desired head simultaneously or some any other shared learning approach in which encoder parameters are learned).

In computer vision, many developments in transfer learning have leveraged supervised pre-training on large, manually annotated image sets such as ImageNet. There are various examples of successful transfer learning approaches with ImageNet features; that is, features learned from the 14 million or so “generic” images in the ImageNet database that have been manually annotated in respect of over 20,000 image classes. However, despite those successes, supervised feature learning approaches are inherently limited in their reliance on manually annotated features.

“Self-supervised” approaches seek to address these issues. Self-supervised learning mirrors the framework of supervised learning, but with the aim of removing or reducing the need for manual annotations by deriving the ground truth, \tilde{y}, for the dummy task automatically, i.e., given a set of training inputs {\tilde{x}}, to automatically generate a training set {(\tilde{x}, \tilde{y})} for the dummy task without manual annotation. Outside of perception, an example of a successful self-supervised approach is the Word2Vec model the field of Natural Language Processing (NLP). In training, each input, \tilde{x}, is a word taken from a training document, and the ground truth, \tilde{y}, is derived automatically as a set of adjacent words; in training the task is, therefore, to learn to predict likely adjacent words given an input word. This approach has been demonstrated to be highly effective at learning semantically rich features for words that can then be applied to other tasks such as document classification.

Whilst self-supervised feature-learning tasks have also been explored in computer vision, they have been largely unable to match the performance of pre-training on the manually annotated ImageNet images.

The “SimCLR” architecture is a recent and promising development in self-supervised feature learning for computer vision. For further details, see “A Simple Framework for Contrastive Learning of Visual Representations”, Chen et. al. (2020); arXiv:2002.05709, incorporated herein by reference in its entirety. SimCLR adopts a “contrastive learning” approach, where training data is generated automatically via image transformations. A stochastic data augmentation module transforms a given image randomly resulting in two correlated “views” of the image, \tilde{x}ᵢ and \tilde{y}ⱼ. Those views are said to be “associated” and constitute a “positive pair”. The training also uses “negative” image pairs that are not expected to have any particular association with each other. The self-supervised task is that of identifying positive pairs. That task is encoded in a contrastive loss function that encourages the network to extract similar features for two images of a positive pair, whilst discouraging similarity of features for two images of a negative pair.

### SUMMARY

In SimCLR and other existing contrastive learning approaches, given a set {\tilde{x}ₖ} that includes some positively paired inputs \tilde{x}ᵢ and \tilde{y}ⱼ, the task is to identify (predict) the correct \tilde{x}ⱼ given \tilde{x}ᵢ. The contrastive loss encodes only binary relationships between examples in the training set: two inputs either constitute a positive pair (because the inputs are associated in the above sense) or a negative pair (because the inputs have no particular relation to each other), and the aim is to train the system to distinguish between those two possibilities. This resembles a classification task where the aim is to predict some class label \tilde{y}ⱼ for a given input \tilde{x}ᵢ.

By contrast, herein, a novel regression-based self-supervised learning approach is disclosed. The present approach also exploits known associations between training inputs of a training set. A positive training example refers to two or more training inputs that are associated in the sense of discernibly corresponding to the same set of sensor data (correlation) and being related to each other by at least one transformation. The transformation could be a spatial/geometric transformation such as rotation, cropping, resizing etc., or a noise transformation such as colour distortion, blur etc., or any combination thereof.

The present techniques can be applied with any transformation that is parameterized by at least one numerical value. Features are learned via training on a dummy regression task of predicting the numerical value(s) that parameterize the transformation between associated training inputs.

Unlike existing contrastive learning approaches, the aim is not simply to learn to identify associated training inputs, but rather to learn to quantify the relationship between associated training inputs based on their respective features. This task is encoded in a self-supervised regression loss.

A first aspect herein provides computer implemented method of training an encoder to extract features from sensor data, the method comprising:
generating a plurality of (positive) training examples, each training example comprising at least two data representations of a set of sensor data, the at least two data representations related by a transformation parameterized by at least one numerical transformation value; and
training the encoder based on a self-supervised regression loss function applied to the training examples;
wherein the encoder extracts respective features from the at least two data representations of each training example, and at least one numerical output value is computed from the extracted features, wherein the self-supervised regression loss function encourages the at least one numerical output value to match the at least one numerical transformation value parameterizing the transformation.

A dummy task that more closely resembles the desired task may yield better features for the purpose of the desired task. Better features, in turn, can improve the performance and/or reduce the training requirements for the desired task. A motivation for the present regression-based self-supervised task is to learn representations that are better for other desired tasks that are also regression-based, such as object localization (predicting object position, pose and/or size/extent). For example, it might be that the desired task is pose detection; that is, predicting the pose (orientation) of some object captured in a training input based on features extracted by an encoder. This desired task can be naturally formulated as a regression task with respect to ground truth object poses, e.g., using a conventional supervised approach on a relatively small set of manually annotated training data. In this context, to train the encoder, a large training set may be generated that includes associated training inputs that are related by rotation, and the dummy regression task might be to predict a relative rotation angle between associated training inputs. Compared with a conventional contrastive learning task, this dummy task more closely resembles the desired task (because both tasks are formulated as regression tasks with respect to angle) and may therefore provide better features for the latter.

Whilst existing contrastive learning approaches such as SimCLR might generate a training set using transformations that happen to be parameterized by some numerical value(s) (such as rotation, resizing etc.), that information is not incorporated in the SimCLR contrastive learning loss. Rather, the SimCLR contrastive learning loss simply encodes binary categorical relationships between different training examples (associated vs. not associated). In contrast, the present self-supervised regression loss encodes the numerical value(s) parameterizing the transformation between associated training inputs (e.g., rotation angle) and causes the transformation prediction component to try to predict that value(s) from the extracted features.

In the above, the term data representation refers to some lower-level representation of the sensor data or some transformed version thereof, and includes, for example, image, point cloud, voxel or mesh representations and the like. The term “input” is used as shorthand for such a data representation unless otherwise indicated. By contrast, a feature representation refers to some higher-level representation extracted by the encoder. When the term representation is used without modification, the meaning shall be apparent from the context. Terms such as feature learning and representation learning are used as shorthand to refer to the training of the encoder based on the dummy task unless otherwise indicated.

In embodiments of the first aspect, the encoder may extract local features from each data representation. That is, respective local features may be extracted for respective subsets (e.g. grid cells) of the data representation. For example, for an image or voxel representation, the local features could be per-pixel/voxel or per-2D or 3D region features for some or all pixels/regions/voxels. For a point cloud representation, the local features could be per-point or per-region of the point cloud, etc.

In some embodiments, the transformation itself may be global (e.g., global rotation, global resizing etc.) and the parameter may be a global parameter of the transformation. However, this does not preclude the learning of local features. For example, the transformation prediction may compute an output value for each subset of the data representation, from that subset's local features. For each subset, the output value may be matched to the value(s) of the global transformation parameter. Conceptually, this trains the transformation prediction component to predict a local transformation value(s) for each subset—it just so happens that the local transformation value(s) are invariant for any given training example.

In embodiments, the respective features may be respective local features contained in respective feature maps extracted from the at least two data representations.

The transformation may comprise a global transformation and the at least one numerical transformation value may comprise a global transformation value, with multiple numerical output values computed from the extracted local features, and the loss function encouraging each of the multiple numerical output values to match the global transformation value.

The transformation may comprise one or more local transformations and the at least one numerical transformation value may comprise one or more local transformation values, with multiple local numerical output values computed from the extracted local features, and the loss function encouraging each of the local numerical output values to match a corresponding one of the local transformation values.

Each local numerical output value may be determined based on a mapping between a spatial location of a first of the data representations and a second spatial location of a second of the data representations.

The transformation may be fully or partially geometric, in which case the mapping may be determined from the transformation.

Each local numerical output value may be computed by comparing a first vector or scalar and a second scalar or vector, where the first vector or scalar may be defined by the first spatial location and the feature map of the first data representation, and the second vector or scalar may be defined by the second spatial location and the feature map of the second data representation.

The first and second vectors or scalars may be computed from the feature maps using a trainable projection component that is trained simultaneously with the encoder.

The transformation may comprise global rotation and the at least one at least one numerical transformation value may comprise a global rotation angle. Each local numerical output value may be computed as an angular separation between the first vector and the second vector, and the loss function may encourage each of the local numerical output values to match the global rotation angle.

The transformation may comprise local rotations and the at least one numerical transformation value may comprise multiple local rotation angles. Each local numerical output value may be computed as an angular separation between the first vector and the second vector, and the loss function may encourage each of the local numerical output values to match a corresponding one of the multiple local rotation angles.

The mapping may be from a grid cell of the first data representation to a grid cell of the second representation, and the first and spatial second locations may be grid cell locations.

Alternatively, the mapping may be from a grid cell of the first data representation to a region of the second representation spanning multiple grid cells thereof, and the second vector or scalar may be determined via interpolation of vectors or scalars of the multiple grid cells.

The transformation may comprise rescaling, translation, cropping and/or tearing as parameterized by parameterized by the at least one numerical transformation value.

The transformation may comprise at least one non-geometric transformation, such as the addition of noise, that is parameterized by the at least one numerical transformation value.

With local transformation, a 2D object detector may be applied to an image other than the at least two data representations in order to determine the local transformations for one or more objects detected in the image, the image containing or associated with the sensor data.

The data representations may encode views of the sensor data in a plane other than an image plane of the image.

The data representations may, for example, be image or voxel representations.

The data representations may, for example, be image or voxel representations of 2D or 3D point clouds.

A second aspect herein provides an encoder trained in accordance with the method of the first aspect or any embodiment thereof.

A third aspect herein provides a computer system comprising such an encoder and a perception component. The encoder is configured to receive an input sensor data representation and extract features therefrom, and the perception component is configured to use the extracted features to interpret the input sensor data representation.

The perception component be configured to perform a regression task on the extracted features.

A fourth aspect herein provides a training computer program configured, when executed on one or more computer processors, to implement the method of the first aspect or any embodiment thereof.

### BRIEF DESCRIPTION OF FIGURES

For a better understanding of the present disclosure, and to show how embodiments of the same may be carried into effect, reference is made by way of example only to the following figures in which:

FIG. 1 shows a schematic overview a regression-based pretext training architecture;

FIG. 2 shows an example birds-eye-view (BEV) representation of a point cloud;

FIG. 3 shows two BEV images of the same point cloud that are related by global rotation and demonstrates how local rotation predictions may be computed based on a comparison of their local features;

FIG. 4 shows an example encoder and projection layer architecture for regression-based pretext training;

FIG. 5 shows how mappings between spatial locations in paired BEV images may be determined in order to compute local transformation predictions from their respective local features;

FIGS. 6 and 7 show expanded views of the example BEV images of FIG. 3;

FIG. 8 shows a grid cell in a first BEV image mapped to a region of a second BEV image under an example rotation transformation;

FIG. 9 shows how a 2D object detector may be used to generate paired images via the application of object-specific local transformations;

FIG. 10 shows a block diagram for an interleaved training architecture;

FIG. 11 shows a schematic block diagram of a computer system configured to implement a trained encoder; and

FIG. 12 shows how 2D bounding boxes detected an image can be projected into a 2D or 3D space of a lidar or radar point cloud.

### DETAILED DESCRIPTION

As discussed, shared learning approaches seek to learn feature representations that generalize to other tasks. In the described embodiments, a dummy (pretext) task for feature learning is constructed as a self-supervised regression task with respect to a training set. The training set includes training inputs that are associated in the above sense and related by some transformation. The task is one of predicting numerical value(s) parameterizing the transformation between associated training inputs of a positive training example (e.g., positive pair) based on their respective features.

The transformation is used as a pair generation function for generating positive pairs of inputs, but the use of those positive pairs is quite different from conventional contrastive learning in the regression approach described herein.

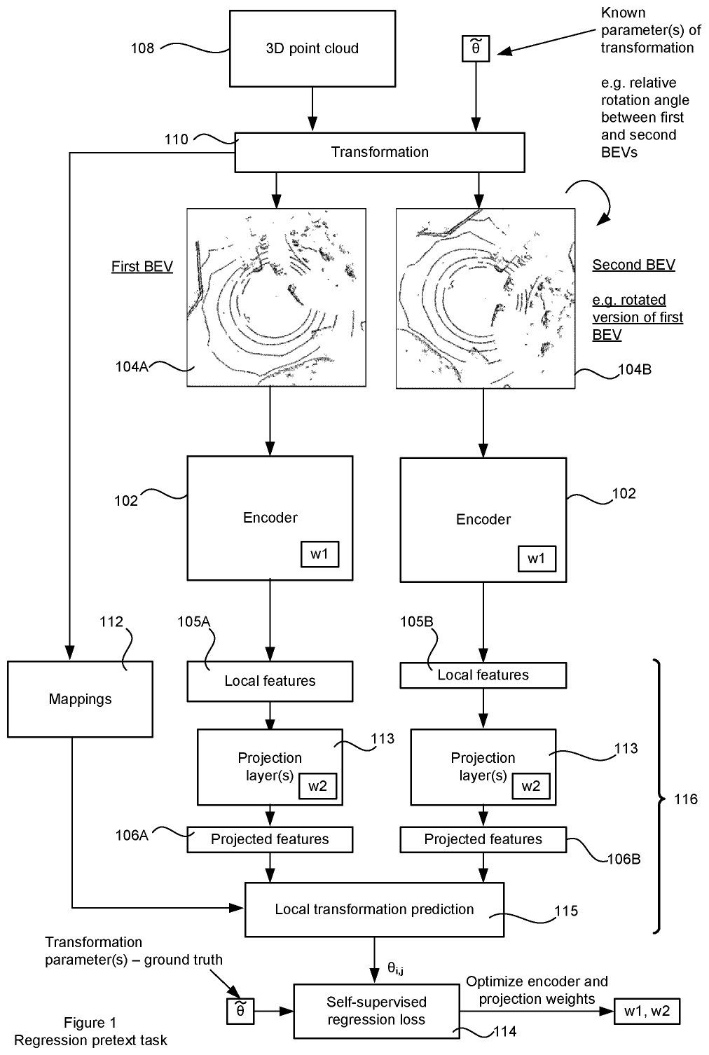

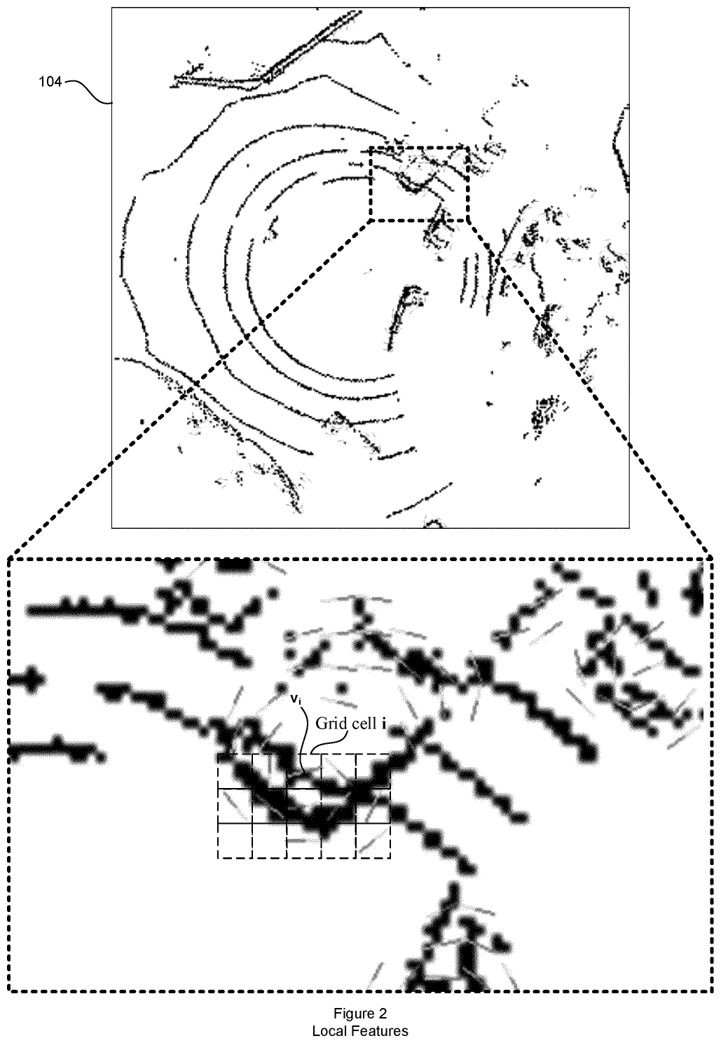

The dummy task is encoded in a pretext loss, which is self-supervised regression loss (FIG. 1, 114) that penalizes deviation between the numerical output of a dummy regression component (head) and the numerical value(s) parameterizing the transformation for a given positive pair. The features are extracted by an encoder and feed into the dummy regression head (FIG. 1, 116) for computing the numerical output, and the encoder and the dummy regression component are trained together with the objective of substantially optimizing the self-supervised regression loss over a training set. That is, both parameters (wights) of the encoder and parameters of the dummy regression head are tuned in a structured training process with the objective of substantially optimizing the self-supervised regression loss over the training set.

For example, where two inputs of a positive training example are related by rotation or rescaling, the dummy regression task may be to predict a relative angle of rotation, a relative scaling factor, or a relative noise level between associated inputs based on their respective features. This does not require manual annotation if the numerical value(s) are known from the generating of the training set.

For the purposes of illustration, the following examples consider training inputs in the form of image representations of sensor data, i.e., sensor data represented in a structured two-dimensional (2D) pixel array. Note that a 2D image representation does not necessarily imply 2D image data—for example, an RGBD (Red Green Blue Depth) image encodes explicit depth values in the pixels in order to encode 3D image data. Similarly, an image representation is not necessarily restricted to image modalities in the conventional sense. For example, the underlying sensor data could be point cloud data captured using lidar, which is ordered and discretised to generate an image representation of the point cloud. For example, a PIXOR representation of a point cloud is an image representation that encodes a “birds eye view” (BEV) of the point cloud, using occupancy values to indicate the presence of absence of a lidar point and, in some case, height values to fully represent the 3D lidar data (similar to the depth channel of an RGBD image). For further details, see Yang et al, “PIXOR: Real-time 3D Object Detection from Point Clouds”, arXiv:1902.06326, which is incorporated herein by reference in its entirety.

Unless otherwise indicated, the term “image” herein simply means an image representation in this sense and does not necessarily any limitation on the modality of the underlying sensor data. A benefit of using image representations is that many state-of-the-art CNN architectures from computer vision are designed to operate on this type of input. Nevertheless, it will be appreciated that the described techniques can be applied to other data representations, such as voxel, point cloud or mesh representations. For example, PointNet is one example of a convolutional neural network architecture that operates directly on point cloud representations and does not require them to be converted to intermediate image representations. Moreover, many 2D CNN architectures can be extended to operate on 3D voxel representations at the cost of increased resource requirements.

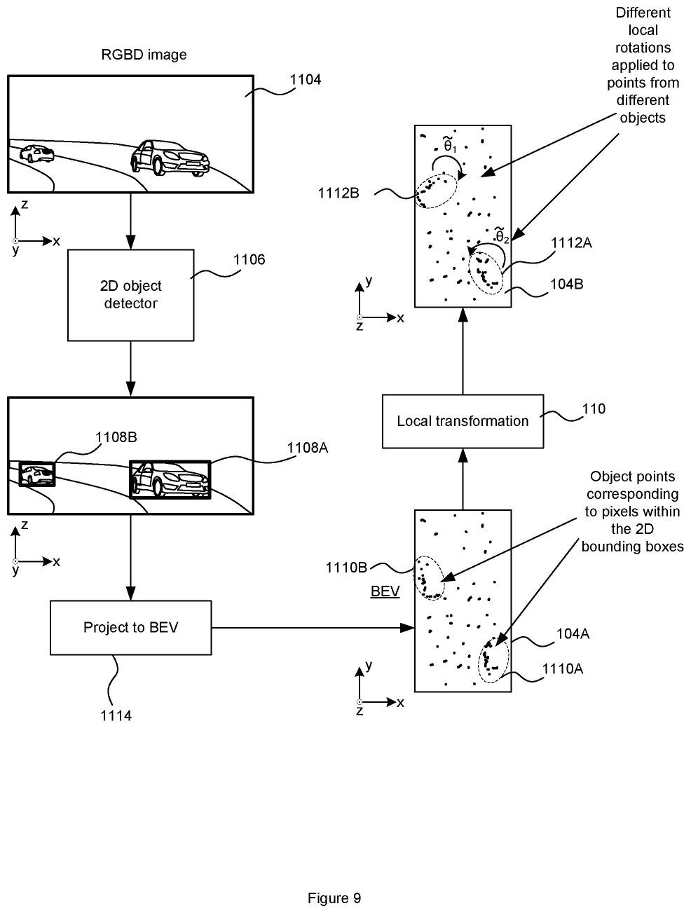

The described examples consider an ML system having a neural network architecture; that is, a computer system programmed to implement a neural network, such as a deep CNN architecture, having an encoder portion (encoder layers, which are typically convolutional) and at least one dummy regression head. In this context, the parameters of the encoder and the dummy regression head comprise weights of the neural network that are applied at the various layers. During pre-training, the network is trained end-to-end, with both the encoder weights and the weights of the dummy regression head being systematically updated with the objective of optimizing a self-supervised pretext regression loss constructed in accordance with the above principles. A desired regression head is trained, e.g., using a conventional supervised approach but with a greatly reduced training set, and operates on features provided by the encoder. Further details of training are described below with reference to FIG. 9.

FIG. 1 schematically illustrates a dummy regression task applied to 3D lidar point clouds based on transformation angle.

The aim is to train an encoder 102 to extract high-quality local features from point clouds that are well suited to other, more useful regression tasks, such as object localization (e.g., bounding box detection, location detection, pose detection etc.).

FIG. 1 shows a 3D point cloud 108 and first and second training images 104A, 104B (that is, discretised 2D representations) of the 3D point cloud 108. Each of the training images 104A, 104B is a BEV image representation of the same 3D point cloud 108, and the training images 104A, 104B are therefore associated in the above sense and constitute a positive pair. The training images 104A, 104B are generated from the 3D point cloud 108 by a transformation 110 applied to the point cloud 108 and provide relatively transformed BEVs of the 3D point cloud 108. Specifically, those views are relatively rotated in the BEV plane by some relative rotation angle rotation angle \tilde{θ}, which is a numerical parameter of the transformation 110.

The first and second training images 104A, 104B are relatively sparse images, in that the majority of their pixels do not correspond to any point in the point cloud 108. Such pixels are said to be unoccupied, whereas pixels that do correspond points in the point cloud 108 are said to be occupied. Each pixel may, for example, have a binary occupancy value for denoting occupancy. When a first pixel in the first training image 104A and a second pixel in the second training image 104B correspond to the same point in the point cloud 108, those first and second pixels correspond to each other. Note that, generally, those pixels will be at different locations in their respective images 104A, 104B because of the relative rotation between those images 104A, 104B. Mappings 112 between regions of the first training image 104A and corresponding regions of the second training image 112 are known from the transformation 110.

The first and second training inputs 102 are each processed by the encoder 102, based on a set of encoder weights w₁, in order to extract first and second local features 105A, 105B respectively.

A projection component 113 projects the local features 105A, 105B from a feature space into a projection space to obtain first and second feature projections 106A, 106B for the first and second images 104A, 104B respectively.

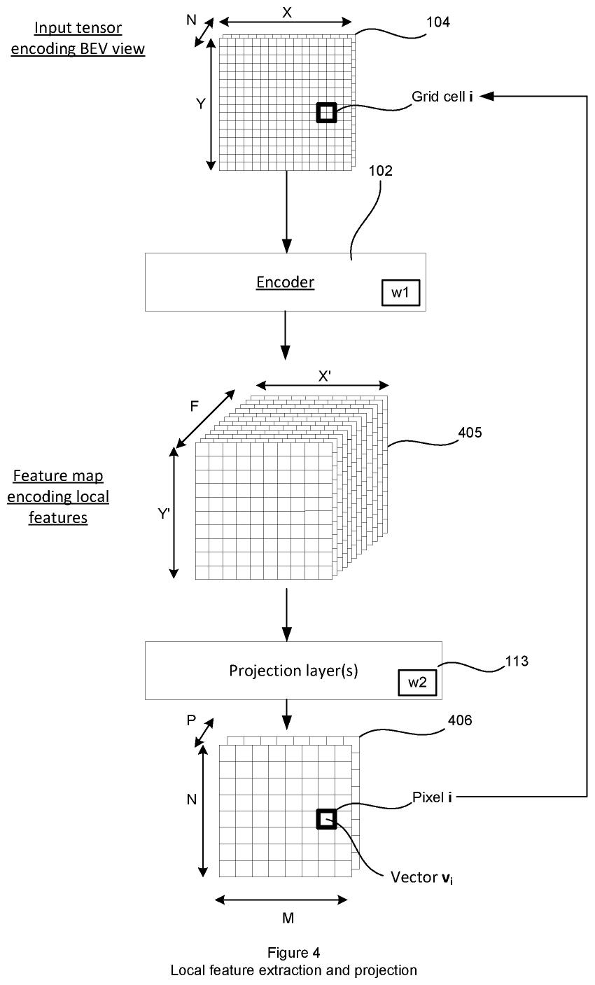

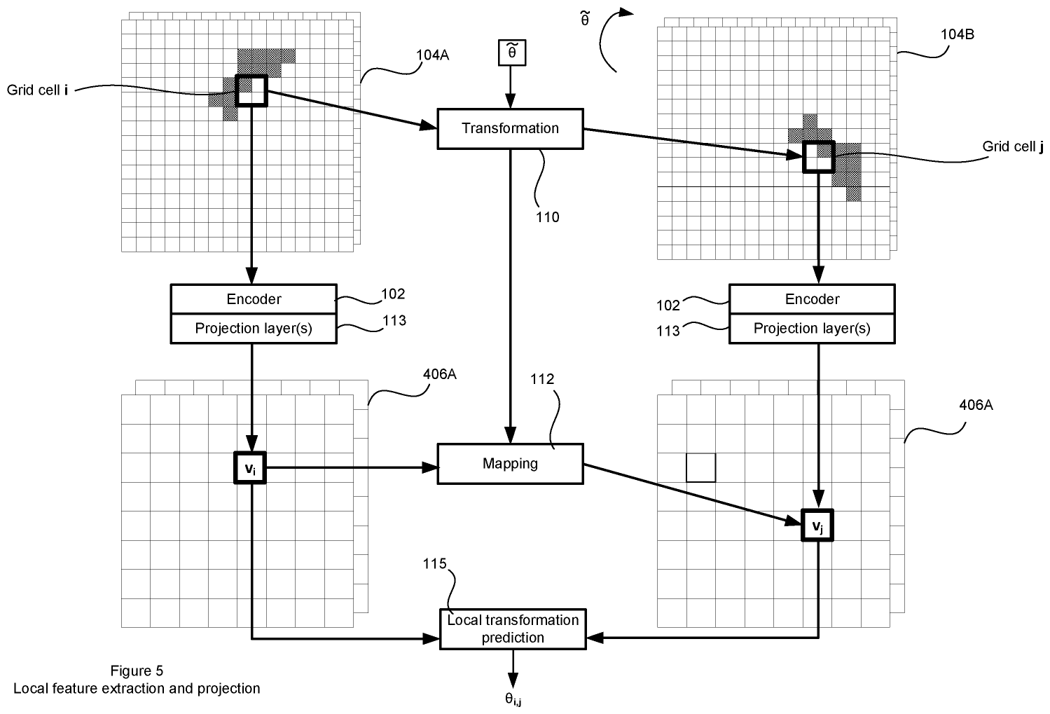

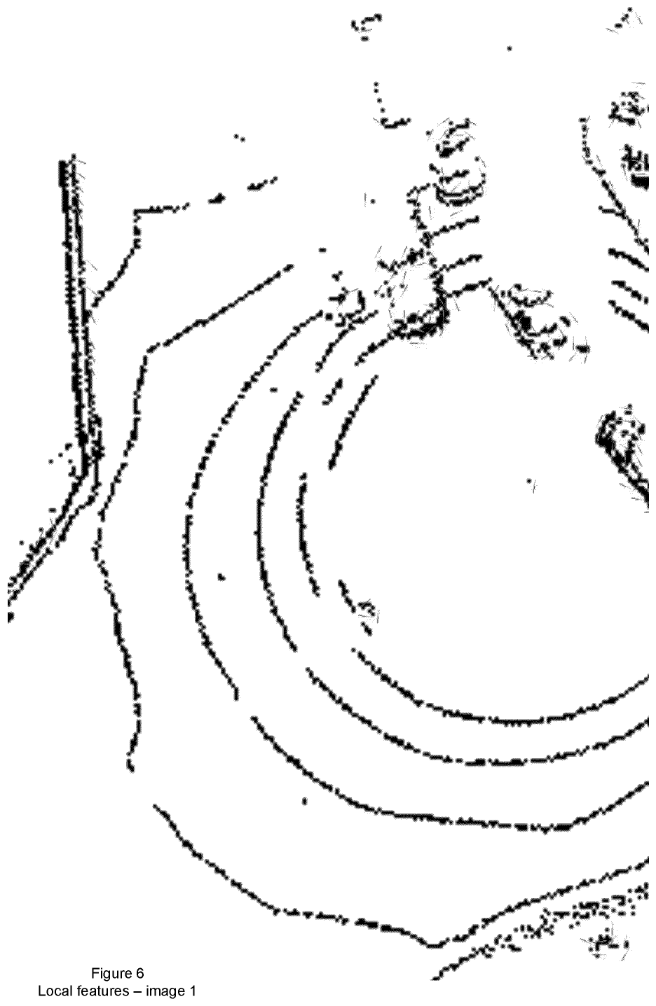

FIG. 4 is a schematic block diagram illustrating the relationship between an image 104 and its features in more detail. The image 104 is encoded as an input tensor shown to have spatial dimensions X×Y with N channels. In the simplest case N=1, e.g., for a BEV image representation of a point could with only an occupancy channel. However, N may be greater than one, e.g. N=2 for a BEV image with occupancy and height channels.

In this example, the encoder 102 has a CNN architecture. The local features extracted by the encoder 102 are encoded in a feature map 405, which is a second tensor having spatial dimensions X′×Y′ and F channels. The number of channels F is the dimensionality of the feature space. The size of the feature space F is large enough to provide rich feature representations. For example, of the order of a hundred channels might be used in practice though this is context dependent. There is no requirement for the spatial dimensions X′×Y′ of the feature map 405 to match the spatial dimensions X×Y if the image 104. If the encoder 102 is architected so that the spatial dimensions of the feature map 405 do equal those of the input image 104 (e.g., using upsampling), then each pixel of the feature map 405 uniquely corresponds to a pixel of the image 104 and is said to contain an F-dimensional feature vector for that pixel of the image 104. When X′<X and Y′<Y, then each pixel of the feature map 405 correspond to larger region of the image 104 that encompasses more than one pixel of the image 104.

The first and second sets of local features 105A, 105B of FIG. 1 are tensor-encoded in this manner.

The encoder 102 computes the feature map 405 through a combination of convolutional and non-linear operations applied within the layers of the encoder 102 based on the encoder weights w₁.

The feature projections computed by the projection component are encoded in a projection map 406, which is a third tensor having spatial dimensions M×N and P channels. Again, there is no requirement that the spatial dimensions M×N of the projection map 406 match the spatial dimensions X×Y of the original image 104 or the spatial dimensions X′×Y′ of the feature map 405 computed by the encoder 102 (the latter may be referred to as the full feature map 405 to distinguish from the projection map 406). The first and second feature projections 106A, 106B of FIG. 1 are encoded in this way.

The projection component 113 can be implemented as a single layer with projection weights w₂. Whilst a single layer is sufficient, multiples layers can be used.

A pixel of the projection map 405 is denoted i and contains a P-dimensional vector vᵢ (projected vector). Pixel i of the projection map 405 corresponds to a grid cell of the image 104—referred to as grid cell i for conciseness. Grid cell i is a single pixel of the original image 104 when the spatial dimensions of the projection map 405 match the original image 104 but is a multi-pixel grid cell if the projection map 405 has spatial dimensions less than the original image 104. In the following examples, the size of the projection space P=2. In training on the pretext regression task, the vector vᵢ is interpreted as a vector lying in the BEV plane.

FIG. 2 illustrates the interpretation of the local feature projections using a real example of a lidar point cloud captured in a driving context. The point cloud is encoded as a BEV image and an expanded view of part of the image is shown in the bottom part of FIG. 4. Projected vectors are represented graphically as lines in the BEV plane. The relationship between the vector vᵢ and grid cell i can be seen (projection vectors are not shown for all grid cells—see below).

The grid cells correspond to individual pixels of the projection map 406 and, in this example, each grid cell i encompasses multiple pixels within the original image 104. Such grid cells are a natural result of down sampling performed on the input image 104 within the network. If desired, upsampling can be used to counter this effect and obtain a higher-resolution feature map 405. However, in practice, a feature resolution of the order depicted in FIG. 2 has been found to yield good local features.

Certain grid cells are ignored (and do not contribute to the self-supervised loss function 114). To determine whether to ignore a grid cell, the image 104 is interpolated (e.g. via bilinear interpolation) into the same sized space as the projection map 405 (M×N). A loss (penalty) is only suffered in those grid cells where the interpolated BEV occupancy is greater than zero. This is one way to account for the relative sparsity of the BEV image 104. However, it will be appreciated that there are other viable ways to selectively ignore grid cells that that contain no or limited information.

Returning to FIG. 1, the first and second local features 105A, 105B are extracted in this manner from the first and second input images 104A, 104B respectively. The local features 105A, 105B are in turn, projected into the projection space by the projection layer(s) 113 to obtain the local feature projections 106A, 106B.

A local transformation prediction component 115 receives the local feature projections 106A, 106B and computes a local transformation prediction θ_{i,j} for each pair of corresponding grid cells i, j in the first and second images 104A, 104B as follows. In this case, the local transformation prediction θ_{i,j} is a local rotation angle.

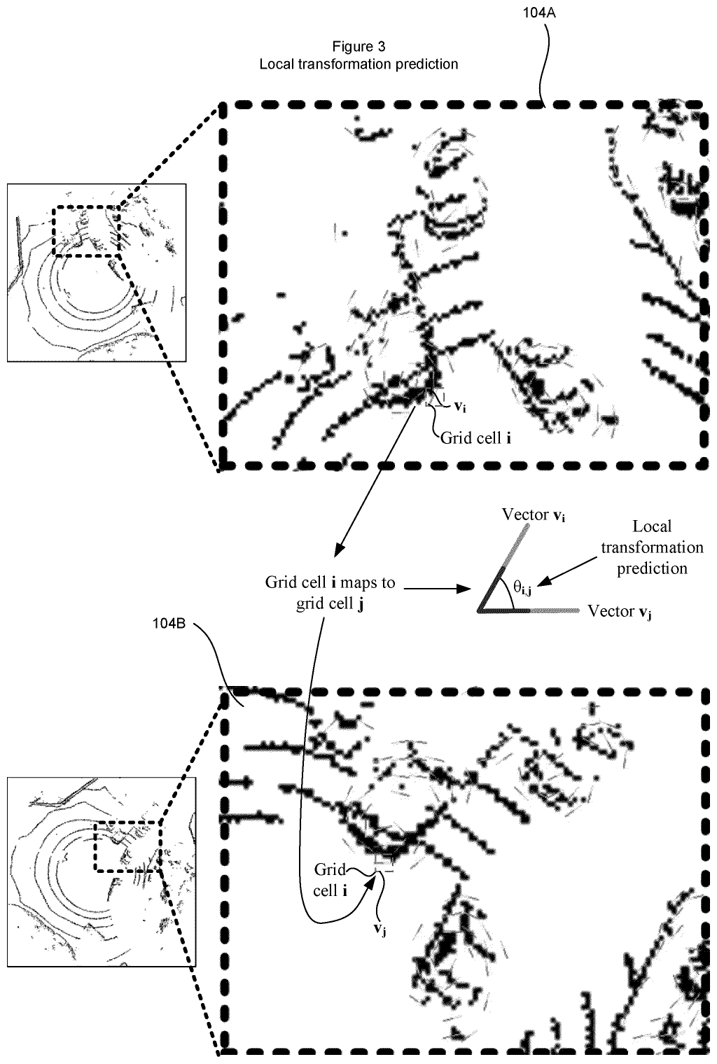

With reference to FIG. 3, grid cell i of the first image 104A is known to map to corresponding grid cell j in the second image 104B because the transformation 110 between those images 104A, 104B (parameterized by \tilde{θ}) is known. That is, a mapping from grid cell i in the first image 104A to grid cell j in the second image 104B is determined from the transformation 110 and its parameter(s) \tilde{θ}. The encoder 102 assigns an F-dimensional feature vector to each of those grid cells i, j and the projection layer(s) 113 assigns those grid cells i and j respective vectors vᵢ, vⱼ in the BEV plane. The local transformation prediction component 115 computes the local rotation angle θ_{i,j} as the angular separation between those vectors vᵢ, vⱼ in the BEV plane, as illustrated towards the middle of FIG. 3.

Returning to FIG. 1, such mappings 112 are determined for multiple grid cell pairs between the two images 104A, 104B. For every pair (i, j) of corresponding grid cells in the first and second training images 104A, 104B, the local rotation angle θ_{i,j} should match the (global) relative rotation angle \tilde{θ} between the first and second training images 104A, 104B. The pretext loss 114 is therefore constructed to penalize deviation in the local rotation angle θ_{i,j} from the global rotation angle \tilde{θ} of the transformation 110:

$${ℒ}_{pre} ( {\tilde{x}}_{a} , {\tilde{x}}_{b} ) = {\sum }_{( i , j ) ∈ {M}_{{\tilde{x}}_{a} , {\tilde{x}}_{b}}} d ( {θ}_{i , j} , \tilde{θ} ) , \qquad ( 1 )$$

where \tilde{x}ₐ, \tilde{x}_{b} denote the first and second images 104A, 104B respectively. The notation T_{\tilde{θ}} denotes the transformation 110 parameterized by \tilde{θ}, with \tilde{x}_{b}=T_{\tilde{θ}}(\tilde{x}ₐ). Here, M_{T}_{_{\tilde{θ}}} is a set of mapping (the mappings 112 shown FIG. 1) and (i, j)∈M_{\tilde{x}}_{ₐ}_{,\tilde{x}}_{_{b}} denotes a pair of corresponding grid cells, i.e., grid cell i in the first image \tilde{x}ₐ, maps to grid cell j in the second image \tilde{x}_{b} under the transformation T_{\tilde{θ}}. The set of mappings M_{T}_{_{\tilde{θ}}} is determined from the transformation T_{\tilde{θ}}, but also depends on the content of the images \tilde{x}ₐ, \tilde{x}_{b} because certain pairs of grid cells are ignored, i.e., excluded from M_{\tilde{x}}_{ₐ}_{,\tilde{x}}_{_{b}}, if they contain no or limited information (see above). Pairs of grid cells that are ignored do not contribute to the pretext loss 114 ( [symbol] ₚᵣₑ) and therefore cannot result in any pretext training penalty. The function d is some difference function (e.g., d(θ_{i,j}, \tilde{θ})=|θ_{i,j}−\tilde{θ}| or (θ_{i,j}−\tilde{θ})² etc.).

As depicted in FIG. 3, for predicting rotation angle, the local transformation prediction θ_{i,j} is derived from the projected vectors vᵢ, vⱼ as

$${θ}_{i , j} = arccos ( \frac{{v}_{i} \cdot {v}_{j}}{‖ {v}_{i} ‖ ‖ {v}_{j} ‖} ) . \qquad ( 2 )$$

That is, the local transformation θ_{i,j} is derived from the dot product of the vector vᵢ for grid cell i in the first image 104A and the corresponding vector vⱼ for the second image 104B.

Note, ∥vᵢ∥=∥vⱼ∥=1 for normalized vectors. Whilst the above examples consider a two-dimensional projection space, normalized vectors in a plane may be represented in one dimension as there is only one degree of freedom (it may, nevertheless, be convenient to retain a two-dimensional projection space for normalized vectors as Equation 2 is somewhat simpler to evaluate with two dimensional vectors).

When training on the pretext regression task, the aim is to find parameters (weights) w₁, w₂ of the encoder 102 and the projection layer(s) 113 that substantially minimize the pretext loss [symbol] ₚᵣₑ across the training set.

It is the definition of Equation 2 that forces the interpretation of the projected vectors vᵢ as lines in the BEV plane (Equation 1 applies more generally to other interpretations—see below). With the definition of Equation 2, the encoder 106 is encouraged to assign local features in a way that encapsulates rotational information. This effect can be observed in FIG. 2—the loss function has caused the encoder 106 to assign local features that “spiral” around an object, encapsulating useful information about not only about its location and extent but also its orientation. As can be observed in the side-by-side comparison of FIG. 3, the collection of local features associated with an object generally rotate with the object and therefore appear to capture useful information about its orientation.

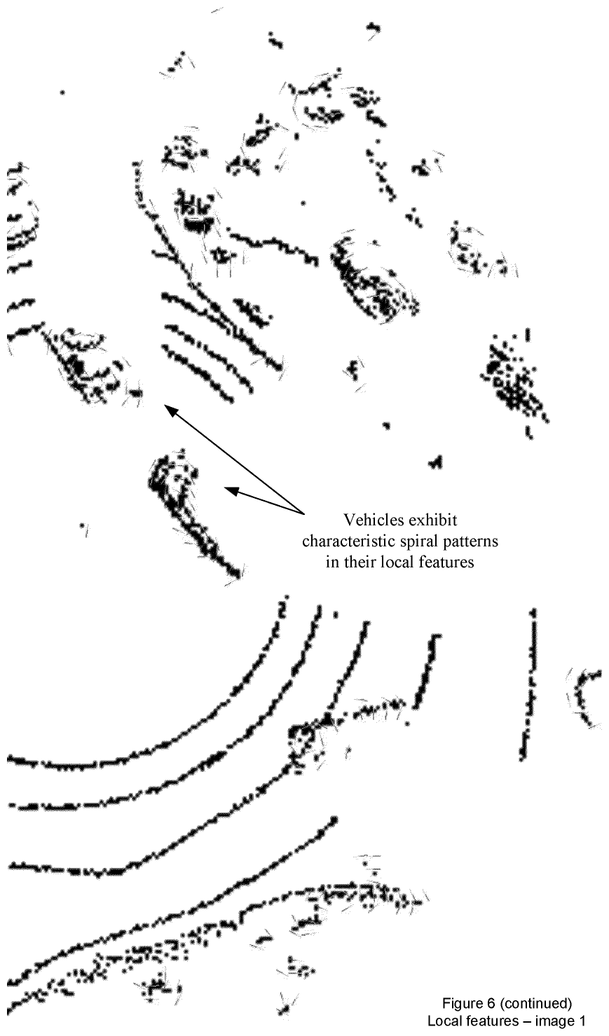

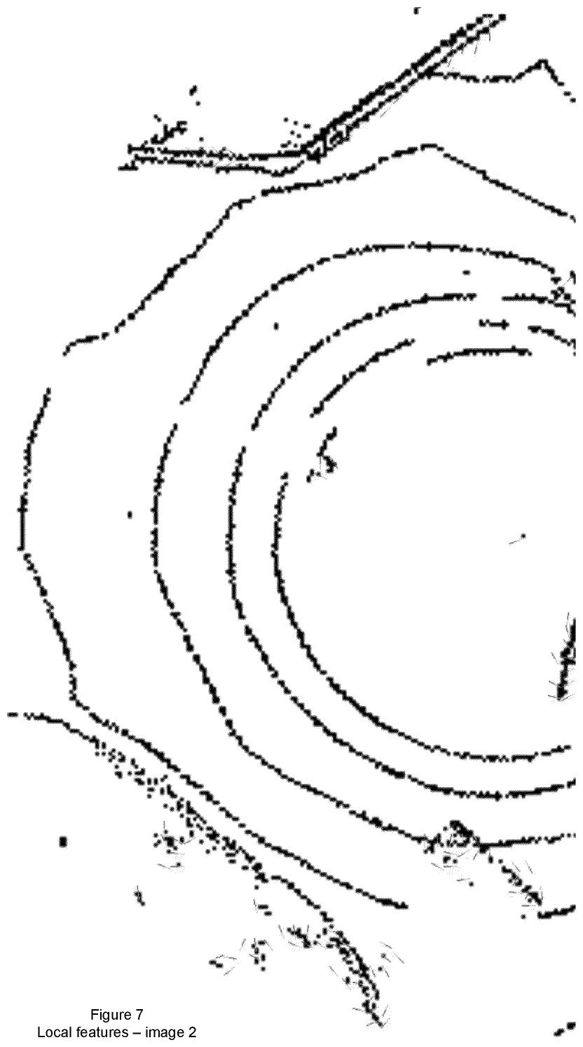

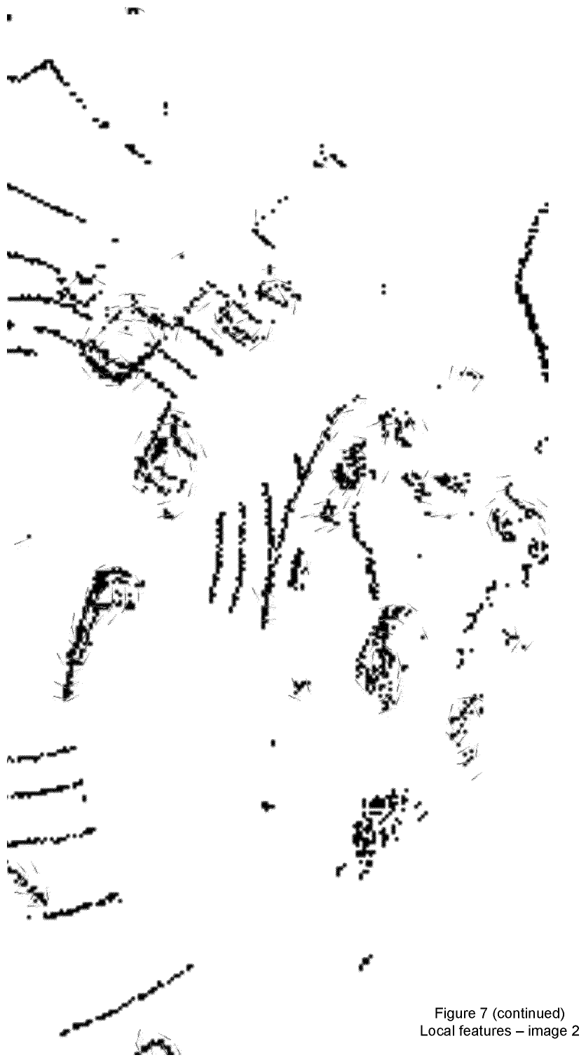

FIGS. 6 and 7 shows enlarged views of the example first and second images 104A, 104B depicted in FIG. 1, marked with their projected vectors to illustrate these effects across the images as a whole.

The mappings M_{T}_{_{\tilde{θ}}} between grid cells in the two images can be determined at different levels of granularity. The above examples consider a course one-to-one mapping from grid cell i in the first image \tilde{x}ₐ to a single grid cell j in the second image \tilde{x}_{b}. This could be determined, for example, by taking a center point cᵢ of grid cell i of the first image 104A, identifying a transformed point cᵢ′=T_{\tilde{θ}}(cᵢ) in the second image \tilde{x}_{b} (the point to which cᵢ maps under the transformation T_{\tilde{θ}}), and determining the corresponding grid cell j as the grid cell containing the transformed point cᵢ′. Course mapping of this nature may well be sufficient in practice. However, it may be possible to improve performance on the pretext task [symbol] ₚᵣₑ with more accurate mappings in some cases.

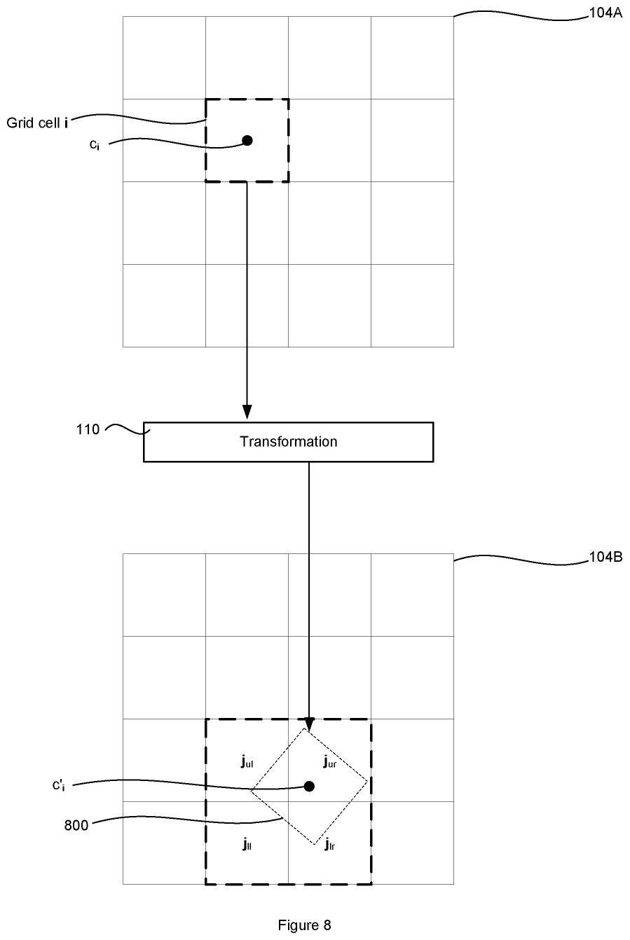

FIG. 8 illustrates how mappings of different granularities may be determined. As can be seen, given a center point c 1 of grid cell i in the first image 104A, the transformed point cᵢ′=T_{\tilde{θ}}(cᵢ) will not, in general lie at the center of any grid cell in the second image 104B (\tilde{x}_{b}). A region 800 of the second image 104B is marked, which is the region to which grid cell i of the first image 104A maps under the transformation T_{\tilde{θ}} (denoted in mathematical notation as T_{\tilde{θ}}(i). As in the earlier examples, FIG. 8 considers a rotation of the first image 104A. In general, this region 800 may intersect up to four grid cells of the second image 104B, denoted {jᵤₗ, jᵤᵣ, jₗₗ, jₗᵣ}. The upper-right grid cell jᵤᵣ is shown to contain the transformed point cᵢ′ in this example. The coarse mapping described above simply takes j=jᵤᵣ, in which case the corresponding vector in the second image is simply vⱼ=vⱼ_{ᵤᵣ}.

Alternatively, the mapping could be refined to account for the full set of grid cells {jᵤₗ, jᵤᵣ, jₗₗ, jₗᵣ}. In this case, the mapping (i, j)∈M_{\tilde{x}}_{ₐ}_{,\tilde{x}}_{_{b}} becomes one-to-many with j={jᵤₗ, jᵤᵣ, jₗₗ, jₗᵣ}. With a one-to-many mapping, given grid cell i in the first image 104A with vector vᵢ, a corresponding vector vⱼ could be determined for the corresponding region 800 of the second image 104B via an appropriately weighted bilinear interpolation of the vectors {vⱼ_{ᵤₗ}, vⱼ_{ᵤᵣ}, vⱼ_{ₗₗ}, vⱼ_{ₗᵣ}}. Equation (2) is unchanged under this definition of vⱼ, with the only difference that vⱼ is now an interpolated vector derived from the set of grid cells j.

Whilst the above examples consider rotation, self-supervised regression-based pretext training approach can be applied much more generally with any form of transformation that can be numerically quantified (and which may or may not be geometric, or which may have a combination of geometric and non-geometric components). Other examples of geometric transformation include rescaling, translation, cropping and “tearing”. Rescaling is a useful transformation for CNN feature learning, as it can help the CNN learn to recognize object patterns in a manner that is sensitive to changes in scale. Once learned on the pretext task, such features may be useful in similar desired tasks such as object size/extent detection. Translation is generally expected to be less useful in the context of CNNs, as the architecture of CNNs makes them invariant to translation. However, translation may nevertheless be useful with other ML architectures. As another example, the transformation could involve cropping the first image 104A. The pretext regression task then becomes one of predicting the numerical parameter(s) quantifying the extent of cropping (note this is not the same as simply identifying cropped/non-cropped image pairs; it is about quantifying the extent of cropping from the extracted features). For example, a useful real-world task might be quantifying the extent of object occlusion or truncation (i.e., predicting the extent to which an object is occluded by some other object or truncated from a sensor field of view). A pretext task that quantifies the extent of cropping in the pair generation may provide useful feature representations for the similar task of quantifying object occlusion in the real world. As a further example, it might be desirable to train a CNN to quantify weather or lighting conditions (e.g., to quantify rain, fog or lighting levels that might impact sensor performance). To construct a similar pretext task, the transformation may introduce some level of noise into the image during pair generation, e.g., by randomly adding and/or removing pixels with some probability; the regression pretext task is constructed as one of quantifying the level of noise that has been introduced from the features (again, this regression task over the noise level is quite different from simply identifying paired images in the presence of noise). Feature representations learned on the noise level regression task may be useful in comparable real-world regression tasks such as detecting rain level, fog level or lighting level (the latter would generally be more relevant to RGBD point clouds). Another example is a tear function that separates (tears) objects in a quantifiable way. The definition of the loss function in Equation (1) still holds, but with θ_{i,j} and \tilde{θ} being predicted and actual transformation parameter(s) more generally. The relationship between the predicted transformation θ_{i,j} and the projection vectors vᵢ, vⱼ is defined by the pretext loss 114—the vectors themselves are simply number arrays of any desired dimensionality (including one). In the above example, the definition Equation (2) means these are interpreted as vectors lying in the BEV plane when the pretext loss 114 is applied. However, to predict other values (for example scale factor, noise level, cropping level), one-dimensional scalars vᵢ, vⱼ could be chosen and θ_{i,j} could instead be defined as some difference between those scalar values (e.g.

$${v}_{i} - {v}_{j} , or \frac{{v}_{i}}{{v}_{j}} etc . ) . $$

This definition forces an interpretation of vᵢ, vⱼ as relative scaling factors, or relative noise/cropping amount etc. which can be matched, in training, to the corresponding actual transformation parameter(s). Alternatively, 2D vectors could be used e.g., to predict scaling in the x and y directions independently. Equation 1 represents a general framework for pretext regression training where θ_{i,j} can be any function that compares vᵢ and vⱼ.

As will be appreciated, given feature maps from two images, the self-supervised regression loss can be defined on any parameter or parameters of any transformation. By comparing the vector or scalar projections vᵢ, vⱼ for each mapping (i, j), a local numerical output value is obtained, and the pretext regression loss function [symbol] ₚᵣₑ penalizes deviation between that local numerical output value and the global transformation parameter \tilde{θ} or the local transformation parameter \tilde{θ}_{i,j} as applicable.

Useful feature representations may be learned for any transformation 110 that preserves sufficient structure of the original image 104 to be detectable to the encoder 102 (which is dependent on the architecture of the encoder 102) and is generally related to some real-world property or properties.

Whatever the desired tasks (or tasks), training can be implemented via a suitable task-specific loss as described in further detail below, e.g., in a conventional supervised manner.

The projection layer(s) 113 and local transformation prediction component 115 constitute a dummy regression head 116. The dummy regression head 116 receives the extracted features and is trained to try to predict the relative rotation angle \tilde{θ} between the two images 104A, 104B. Although the transformation is global in this example (global rotation of the whole image), the transformation prediction component 115 is local in that it is trying to predict the global rotation angle \tilde{θ} for each pair of grid cells based on local features in the feature map 405. The dummy head 116 and encoder 102 constitute an ML system that is trained on the pretext task as described in further detail below.

Whilst in the above examples, the transformation is global and the prediction is local, the described techniques are more generally applicable. A global transformation simply means that the parameter(s) \tilde{θ} (e.g., rotation angle, scaling factor, noise level etc.) happen to be invariant across the image 104A being transformed. The same techniques could be applied with a transformation that is local in the sense that \tilde{θ} can vary across the image 104A. The loss function of Equation (1) can be extended straightforwardly to accommodate variable parameter(s) \tilde{θ}(i, j) that may have different value(s) for different pairings (i, j).

2D object detection can be used as part of the pair generation process. For example, with an RGBD point cloud, 2D object detector could be used to detect object(s) in the image plane. A BEV representation can be determined by projecting pixels of the RGBD image into the BEV plane using the values of the depth channel (D). The points belonging to the object(s) in the BEV plane are known from the 2D object detector output. This could, for example, allow a local rotation, scaling, cropping etc. to be applied to each object in the BEV plane. In other words, 2D object detection can be used to apply object-focused local transformations as part of the pair generation.

This requires a 2D object detector, which may need to be trained on large volumes of data. However, such object detectors are readily available, and it is generally more straightforward to the required volume of annotated images than it is to annotate point clouds etc.

FIG. 9 shows a schematic block diagram of a system for generating paired BEV images based on local (rather than global) rotation in a way that leverages 2D image detection.

An RGBD (Red Green Blue Depth) image is denoted by reference numeral 1102. An RGBD image is a two-dimensional (2D) image representation, in the sense of a 2D array of pixels, but one that explicitly encodes 3D spatial information via a depth channel (D). The depth channel assigns a depth or disparity value to each pixel (or at least some of the pixels) indicating the depth (distance from the image plane) of a corresponding point in 3D space, in addition to the colour values of the RGB channels.

The RGBD image 102 is converted to a BEV image 1104 of the kind described above (by an image projection component 114) using its depth (D) channel. For example, in a stereo imaging context, the depth channel of the RGBD image 103 may contain pixel disparities, which can be transformed to units of distance based on a known stereo camera geometry.

Alternatively, the depth channel may encode pixel depth values in units of distance, thus representing each point of the point cloud 103A directly in 3D space. The BEV is defined as the xy-plane, and the image plane of the original image is shown to lie substantially parallel to the xz-plane.

The original RGBD image 102 is passed to a 2D object detector 1106. The 2D object detector 1106 operates on one or more channels of the RGBD image 102, such as the depth channel (D), the colour (RGB) channels or both. For the avoidance of doubt, the “2D” terminology refers to the architecture of the 2D object detector, which is designed to operate on dense, 2D image representations, and does not exclude the application of the 2D object detector to the depth channel (D).

In this example, the 2D object detector 106 takes the form of a 2D bounding box detector that outputs a set of 2D bounding boxes 1108A, 1108B for a set of objects detected in the RGBD image 102. This, in turn, allows a set of object points 1110A, 1110B in the BEV image 104 to be determined for each detected object (as points corresponding to pixels within that object's 2D bounding box 1108A, 1108B).

Having determined each set of BEV object points 1108A, 1108B, different local transformations can be applied to each set of object points in the BEV image. In this example, different local rotations—by angles \tilde{θ}₁ and \tilde{θ}₂ respectively—are applied to each set of object points 1110A, 1110B in order to generate the paired image 104B (the rotated object points in the second image 104B are labelled 1112A and 1112B respectively). Background points (not belonging to any detected object) are left unchanged in this example.

In pretext training, the task is now to predict the applicable local rotation angle. In this example, there are two detected objects, so the task is to correctly predict the first local rotation angle \tilde{θ}₁ in the vicinity of the first object and the second local rotation angle \tilde{θ}₂ in the vicinity of the second object.

Unless otherwise indicated, the term “3D image” refers to a 2D image representation that explicitly encodes 3D spatial information. Examples of such 3D images include depth images (with or without colour channel(s)), RGBD images and the like.

For point clouds of other modalities, such as lidar or radar, if an image is captured substantially simultaneously with the point cloud, 2D object detection applied to the image can be used in the same way by projecting the 2D bounding boxes into the 2D or 3D space of the point cloud in order to determine the corresponding object points in the point cloud. This means 2D object detection can be applied with any modality of point cloud as a way to provide object-focused local transformation.

Alternatively, with a global transformation, the transformation prediction may also be global. For example, instead of determining a map 406 of projection vectors vᵢ, a fully connected projection layer could be used to project the feature map 405 to a single vector in the projection space. In this case, single vectors vₐ, v_{b} are obtained for the first and second images 104A, 104B respectively, and the summation of Equation (1) reduces to a single term.

One example of a local transformation is a set local rotations within the BEV image 104. Each local rotation would be applied to some subset of points within the image. Another example is scaling or cropping of different parts of the image 104 (with different scaling/cropping factors), introducing different levels of noise in different parts of the image 104, and attempting to quantify the local noise level based on the local features etc.

Whilst example of FIG. 9 considers RGBD point clouds (or, more generally, point clouds encoded in a depth or disparity image), the techniques are not limited in this respect. For point clouds of non-image modalities, such as lidar or radar, 2D object detection can still be leveraged when an image is captured simultaneously with the point cloud (at least approximately).

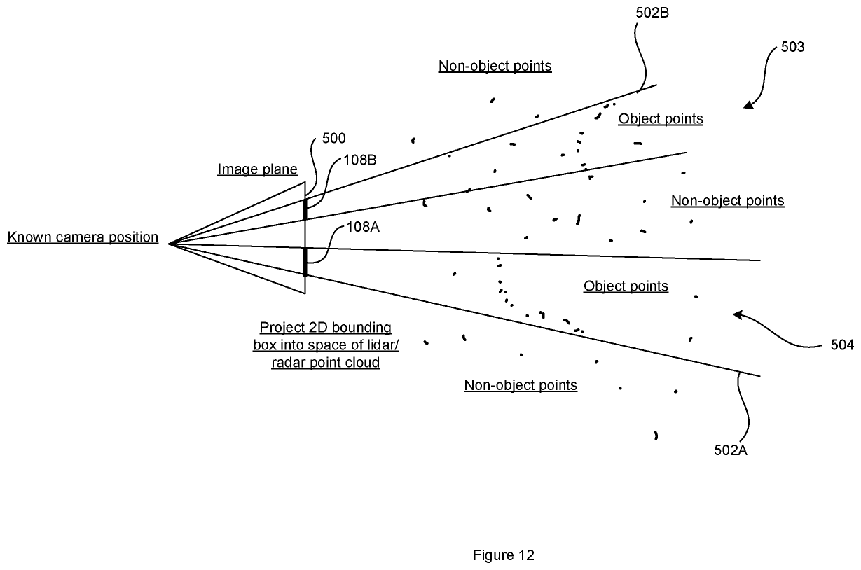

FIG. 12 shows how 2D bounding boxes 108A, 108B, detected in the image plane 500 of an image, may be projected into the 2D or 3D space of an associated point cloud 503 of some other modality. The point cloud 503 has been captured approximately simultaneously with the image. Lidar point clouds are typically captured in 3D space. Radar point clouds are generally 2D and, in an autonomous vehicle context, a radar system would normally be arranged to capture spatial coordinates substantially parallel to the BEV plane based on range and azimuth measurement (although 3D radar systems are now available).

A vehicle may be equipped with at least one image sensor (camera) and at least one other sensor of a different modality, such as lidar or radar. The image sensor is registered with the other sensor. Therefore, a camera position and image plane 500 can be located in the space of the point cloud 503. Based on the known camera position, the 2D boxes 108A, 108B are projected into the space of the point cloud. The projected boxes, labelled 502A, 502B in FIG. 12, are 2D or 3D frustra in the space of the point. This, in turn, allows object points to be identified in the point cloud 503 as point lying within the relevant frustrum 502A, 502B. Background points are points lying outside of any frustra 502A, 502B.

Once object/background points have been identified in this manner, local transformations can be applied as described with reference to FIG. 9. For example, local rotation transformations may be applied to each set of object points, leaving the background points unchanged (effectively rotating each object in the scene).

To predict the 2D boxes 108A, 108B, the 2D object detector 106 is applied to the image as above. The image itself could be an RGBD image, but could also be a conventional colour (e.g. RGB) image in this case.

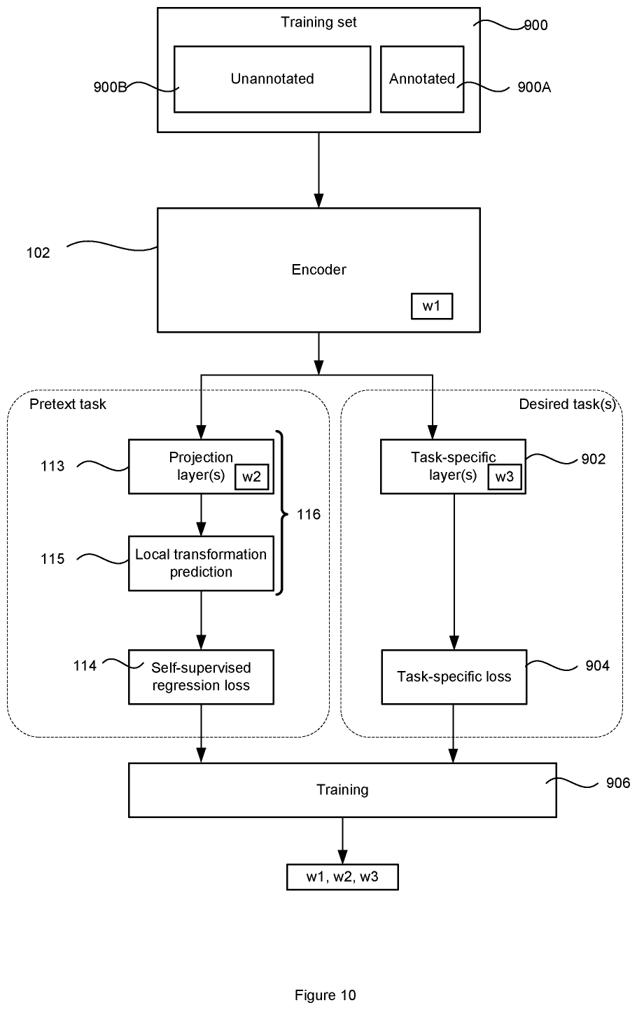

FIG. 10 shows an example of a possible training architecture. In this example, instead of separate pre-training/fine-tuning phases, the training on the pretext task and the training on a desired task are interleaved. The pretext and desired tasks are trained 900 on a common training set in this example. However, only a relatively small subset 900A of the training set 900 is annotated with ground truth for the desired task (e.g., ground truth bounding boxes derived via manual annotation); the remaining subset 900B is unannotated and is only used for the self-supervised pretext training. The encoder 102 is shown connected to the dummy head 116 as in FIG. 1. Additionally, the encoder 102 is also connected to one or more task-specific layer(s) 902 of a desired head, having learnable task-specific weights w 3. A conventional supervised loss 904 may be defined on the desired task(s), with the aim of minimizing the task-specific loss 904 with respect to the annotated subset 900A of the training data 900. A training component 906 is shown, which implements the training method as follows.

Training is performed in a sequence of training steps, each having two phases. In the first phase of each training step, a single update is applied the encoder weights w₁ and projection weights w₂ with the aim of optimizing the self-supervised loss 114 over the full training set 900; then, in the second phase, a single update is applied to the task-specific weights w₃ with the aim of optimizing the task-specific loss 904 over the annotated subset 900A of the training set 900. In the second phase, the encoder weights w₁ may be frozen, or the encoder weights w₁ may be updated for a second time based on the task-specific loss 904, simultaneously with the task-specific weights w₃. In this manner, the task-specific training is “interleaved” with the pretext training.

As will be appreciated, this is just one example of a suitable shared learning training scheme. Alternatively, the encoder 102 and projection layer(s) 113 could be trained in an initial pre-training phase, followed by a fine-tuning phase in which the task-specific layer(s) 902 are trained. Alternatively, a multi-task loss could be constructed that combines the pretext and task-specific losses 114, 904 and all of the weights w₁, w₂, w₃ could be learned simultaneously though optimization of the multi-task loss.

Gradient descent (or ascent) is one example of a suitable training method that may be used.

In the above examples, the projection layer(s) 113 is learned, in the sense of having projection weights w₂ that are learned simultaneously with the encoder weights w₁ during training on the pretext task. The projection layer(s) 113 does not form part of the encoder 102 and the projection weights w₂ may be discarded once pretext training is complete. This architecture is useful to prevent the encoder weights w₁ from becoming overly sensitive to the pretext task. In practice, a single prediction layer 113 has been found to achieve a good balance between, on the one hand, retaining useful knowledge in the encoder 102 and, on the other hand, preventing the encoder 102 from becoming too specific to the pretext task.

However, this may be context dependent and, in some cases, it may be possible to achieve good encoder performance with no projection layers or with multiple projection layers. In a neural network architecture, the projection layer(s) 113 are any layer(s) that are discarded after pretext training (or, more precisely, which are not used for the purpose of the desired task(s)), and the encoder 113 means the remaining layers before the discarded/unused layer(s).

The above examples consider images, but the specific techniques can be readily extended to voxel representations. The same principles of regression-based pretext training can be readily extended to any data representation of spatial sensor data (such as unordered/non-discretised point clouds in 2D or 3D space, surface meshes etc.). The techniques are not specific to point clouds and can be applied to any sensor data (including conventional RGB/colour images). The principles can also be applied to synthetic sensor data, and it is noted that the term sensor data herein covers not only real sensor data but also synthetic sensor data generated using appropriate sensor model(s).

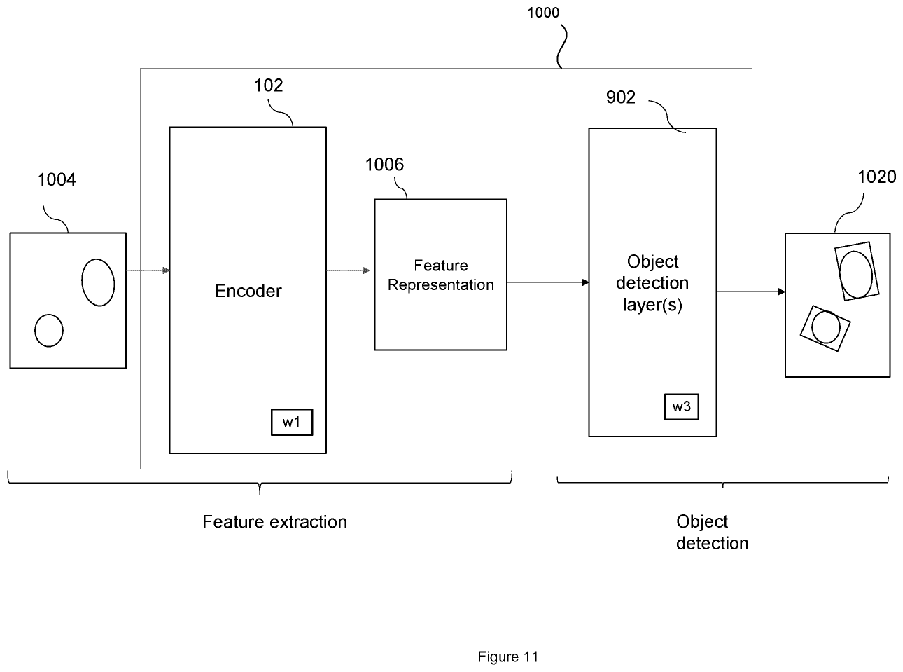

FIG. 11 shows a computer system 1000 configured to implement the trained encoder 102 for a bounding box detection task. An input image or other data representation 1004 is input to the trained encoder 102. A feature representation 1006 is extracted by the trained encoder 102 and passed to the trained task-specific layer(s) 902, which have been trained as a bounding box detector in this example. The encoder 102 and task-specific layers 102, 902 operate on their inputs as described above in the context of training (the feature representation 1006 is a feature map of the same kind extracted in training). The difference is that the weights w₁, w₃ have been learned by this point such that the encoder 102 and object detector 902 are now performing useful tasks. The task-specific layer(s) 902 output a set of object predictions, in the form of predicted bounding boxes 1020. It will be appreciated this is merely one example of a practical application of the trained encoder 102. The task-specific layers 902 can be trained to use the features for any desired task.

Whilst FIG. 11 considers a bounding box detector 902, this is merely one example of a perception component that can use extracted features. Examples of perception methods include object or scene classification, orientation or position detection (with or without box detection or extent detection more generally), instance or class segmentation etc., any of which can be implemented using feature representations learned in accordance with the present teaching.

Herein, the term “perception” refers generally to methods for recognizing patterns exhibited in sensor data representations, such as images, point clouds, voxel representations, mesh representations etc. State-of-the-art perception methods are typically ML-based, and many state-of-the art perception method use deep convolutional neural networks (CNNs). Pattern recognition has a wide range of applications including object detection/localization, object/scene recognition/classification, instance segmentation etc.

Object detection and object localization are used interchangeably herein to refer to techniques for locating objects in point clouds and other data representations in a broad sense; this includes 2D or 3D bounding box detection, but also encompasses the detection of object location and/or object pose (with or without full bounding box detection), and the identification of object clusters. Object detection/localization may or may not additionally classify objects that have been located (for the avoidance of doubt, whilst, in the field of machine leaning, the term “object detection” sometimes implies that bounding boxes are detected and additionally labelled with object classes, the term is used in a broader sense herein that does not necessarily imply object classification or bounding box detection).

References herein to components, functions, modules and the like, denote functional components of a computer system which may be implemented at the hardware level in various ways. This includes the encoder 102, the projection layer(s) 113, the task-specific layer(s) 902, the training component 906 and the other components depicted in FIGS. 1 and 9 (among others). Such components may be implemented in a suitably configured computer system. A computer system comprises one or more computers that may be programmable or non-programmable. A computer comprises one or more processors which carry out the functionality of the aforementioned functional components. A processor can take the form of a general-purpose processor such as a CPU (Central Processing unit) or accelerator (e.g. GPU) etc. or more specialized form of hardware processor such as an FPGA (Field Programmable Gate Array) or ASIC (Application-Specific Integrated Circuit). That is, a processor may be programmable (e.g. an instruction-based general-purpose processor, FPGA etc.) or non-programmable (e.g. an ASIC). Such a computer system may be implemented in an onboard or offboard context in the context of fully/semi-autonomous vehicles and mobile robots. Training may be performed in the same or a different computer system to that in which the trained components are deployed. Training of modern deep networks will typically be carried out using GPUs or other accelerator processors.

References is made to ML models, such as CNNs or other neural networks. This terminology refers to a component (software, hardware, or any combination thereof) configured to implement ML techniques.

1. A computer implemented method of training an encoder to extract features from sensor data, the method comprising:
generating a plurality of training examples, each training example comprising at least two data representations of a set of sensor data, the at least two data representations related by a transformation parameterized by at least one numerical transformation value; and
training the encoder based on a self-supervised regression loss function applied to the training examples;
wherein the encoder extracts respective features from the at least two data representations of each training example, and at least one numerical output value is computed from the extracted features, wherein the self-supervised regression loss function encourages the at least one numerical output value to match the at least one numerical transformation value parameterizing the transformation.

2. The method of claim 1, wherein the respective features are respective local features contained in respective feature maps extracted from the at least two data representations.

3. The method of claim 2, wherein the transformation comprises a global transformation and the at least one numerical transformation value comprises a global transformation value, wherein multiple numerical output values are computed from the extracted local features, and the loss function encourages each of the multiple numerical output values to match the global transformation value.

4. The method of claim 2, wherein the transformation comprises one or more local transformations and the at least one numerical transformation value comprises one or more local transformation values, wherein multiple local numerical output values are computed from the extracted local features, and the loss function encourages each of the local numerical output values to match a corresponding one of the local transformation values.

5. The method of claim 4, wherein each local numerical output value is determined based on a mapping between a spatial location of a first of the data representations and a second spatial location of a second of the data representations.

6. The method of claim 6, wherein the transformation is fully or partially geometric and the mapping is determined from the transformation.

7. The method of claim 5, wherein each local numerical output value is computed by comparing a first vector or scalar and a second scalar or vector, wherein the first vector or scalar is defined by the first spatial location and the feature map of the first data representation, and the second vector or scalar is defined by the second spatial location and the feature map of the second data representation.

8. The method of claim 7, wherein the first and second vectors or scalars are computed from the feature maps using a trainable projection component that is trained simultaneously with the encoder.

9. The method of claim 7, wherein the transformation comprises global rotation and the at least one at least one numerical transformation value comprises a global rotation angle;
wherein at least one local numerical output value is computed as an angular separation between the first vector and the second vector, and the loss function encourages each of the local numerical output values to match the global rotation angle.

10. The method of claim 7, wherein the transformation comprises local rotations and the at least one numerical transformation value comprises multiple local rotation angles;
wherein each local numerical output value is computed as an angular separation between the first vector and the second vector, and the loss function encourages each of the local numerical output values to match a corresponding one of the multiple local rotation angles.

11. The method of claim 7, wherein the mapping is from a grid cell of the first data representation to a grid cell of the second representation, wherein the first and spatial second locations are grid cell locations.

12. The method of claim 7, wherein the mapping is from a grid cell of the first data representation to a region of the second representation spanning multiple grid cells thereof, the second vector or scalar determined via interpolation of vectors or scalars of the multiple grid cells.

13. The method of claim 1, wherein the transformation comprises resealing, translation, cropping and/or tearing as parameterized by parameterized by the at least one numerical transformation value.

14. The method of claim 1, wherein the transformation comprises at least one non-geometric transformation, such as the addition of noise, that is parameterized by the at least one numerical transformation value.

15. The method of claim 4, wherein a 2D object detector is applied to an image other than the at least two data representations in order to determine the local transformations for one or more objects detected in the image, the image containing or associated with the sensor data.

16. The method of claim 15, wherein the data representations encode views of the sensor data in a plane other than an image plane of the image.

17. The method of claim 1, wherein the data representations are image or voxel representations and wherein the data representations are optionally image or voxel representations of 2D or 3D point clouds.

18.-19. (canceled)

20. A computer system comprising:
at least one memory configured to store computer-readable instructions;
at least one hardware processor coupled to the at least one memory and configured to execute the computer-readable instructions, which upon execution cause the at least one hardware processor to extract features from sensor data, by:
generating a plurality of training examples, each training example comprising at least two data representations of a set of sensor data, the at least two data representations related by a transformation parameterized by at least one numerical transformation value; and
training an encoder based on a self-supervised regression loss function applied to the training examples;
wherein the encoder is configured to extract respective features from the at least two data representations of each training example, and at least one numerical output value is computed from the extracted features, wherein the self-supervised regression loss function is configured to encourage the at least one numerical output value to match the at least one numerical transformation value parameterizing the transformation; and
a perception component;
wherein the encoder is configured to receive an input sensor data representation and extract features therefrom, and the perception component is configured to use the extracted features to interpret the input sensor data representation.

21. The computer system of claim 20, wherein the perception component is configured to perform a regression task on the extracted features.

22. A non-transitory medium embodying computer-readable instructions configured, when executed on one or more hardware processors, to train an encoder to extract features from sensor data by:
generating a plurality of training examples, each training example comprising at least two data representations of a set of sensor data, the at least two data representations related by a transformation parameterized by at least one numerical transformation value; and
training the encoder based on a self-supervised regression loss function applied to the training examples;
wherein the encoder extracts respective features from the at least two data representations of each training example, and at least one numerical output value is computed from the extracted features, wherein the self-supervised regression loss function encourages the at least one numerical output value to match the at least one numerical transformation value parameterizing the transformation.
